(19) United States
(12) Patent Application Publication
(10) Pub. No.: US 2017/0213526 A1
(43) Pub. Date: Jul. 27, 2017

(54) DISPLAY APPARATUS

(71) Applicant: DENSO CORPORATION, Kariya-city, Aichi-pref. (JP)

(72) Inventors: Hiroyuki HARA, Kariya-city (JP); Akito TOYODA, Kariya-city (JP); Masaaki KAWAUCHI, Kariya-city (JP); Tadashi KAMADA, Kariya-city (JP)

(73) Assignee: DENSO CORPORATION, Kariya-city, Aichi-pref. (JP)

(21) Appl. No.: 15/328,216

(22) PCT Filed: Jul. 22, 2015
(86) PCT No.: PCT/JP2015/003661

§ 371 Date: Jan. 23, 2017

(30) Foreign Application Priority Data
Aug. 7, 2014 (JP) 2014-161868

(51) Int. Cl. G09G 5/395

(52) U.S. Cl. CPC G09G 5/395; H04N 5/23293

(57) ABSTRACT

A display apparatus includes: a processing device receiving video signals of a video image by an image capturing device and processes an image of a frame in a viewable state based on the video signals to generate display signals; a display device receiving the display signals from the processing device and continuously displays, on a screen, images of a plurality of frames included in the display signals to display the video image; a setting device setting, for each frame, identification information to identify successive frames among the plurality of frames included in the display signals; and a detection device comparing the identification information of one frame of the image displayed on the display device with the identification information of a next one frame of the image displayed on the display device, and detecting that the screen of the display device freezes when both of the identification information are identical.

### CROSS REFERENCE TO RELATED APPLICATION

This application is based on Japanese Patent Application No. 2014-161868 filed on Aug. 7, 2014, the disclosure of which is incorporated herein by reference.

### TECHNICAL FIELD

The present disclosure relates to a display apparatus that displays a video image captured using an image capturing device.

### BACKGROUND ART

For example, Patent Literature 1 proposes a display device configured to prevent malfunction in case that a clock signal stops to protect display elements. Specifically, the display device receives the clock signal and generates common signals, and brings driving elements into the conducting state based on the common signals, operating the display elements. When detecting that the clock signal is shifted to the stopped state, the display device cancels the common signals, thereby bringing the driving elements into the interrupted state to stop the operation of the display elements. This prevents malfunction of the display elements. This also protects the display elements against failure caused by unnecessary lighting, that is, malfunction and excessive current.

According to the conventional technique, when the clock signal is shifted to the stopped state, the operation of the display elements can be stopped. However, when the screen of the display device freezes, the operation of the display elements cannot be stopped.

The state where the screen freezes means that, while a video image captured by an image capturing device is displayed on the display device, the image of the same frame is continuously displayed to display the same image. In this state, the same image, in place of the video image, is continuously displayed on the display device. No mechanism for detecting that the screen freezes has been proposed.

### PRIOR ART LITERATURES

### Patent Literature

Patent Literature 1: JP H5-158430 A

### SUMMARY OF INVENTION

It is an object of the present disclosure to provide a display apparatus capable of detecting that a screen freezes.

A display apparatus according to an aspect of the present disclosure includes: a processing device that receives video signals of a video image captured by an image capturing device and processes an image of a frame in a viewable state based on the video signals to generate display signals; a display device that receives the display signals from the processing device and continuously displays, on a screen, images of a plurality of frames included in the display signals to display the video image; a setting device that sets, for each one frame of the plurality of frames, identification information to identify successive frames among the plurality of frames included in the display signals; and a detection device that compares the identification information of one frame of the image displayed on the display device with the identification information of a next one frame, which is next to the one frame, of the image displayed on the display device, and detects that the screen of the display device freezes when both of the identification information of the one frame and the identification information of the next one frame are identical.

With this configuration, since the setting devices can set different identification information to successive frames of the image, the detection device can detect whether the image continuously displayed on the screen of the display device is the image of the same frame. Therefore, a freeze of the screen of the display device can be detected.

### BRIEF DESCRIPTION OF DRAWINGS

The above and other objects, features and advantages of the present disclosure will become more apparent from the following detailed description made with reference to the accompanying drawings. In the drawings:

FIG. 1 is a view illustrating configuration of an electronic mirror system in a first embodiment of the present disclosure;

FIG. 2 is a view illustrating specific configuration of an ECU and a display device in FIG. 1;

FIG. 3 is a view illustrating an example of a code given to a frame;

FIG. 4 is a schematic view illustrating an effective display area as a screen of the display device;

FIG. 5 illustrates an example of a method of correcting a freeze of the screen;

FIG. 6 is a view illustrating configuration of an ECU and a display device in a second embodiment of the present disclosure;

FIG. 7 is a view illustrating configuration of an ECU and a display device in a third embodiment of the present disclosure;

FIG. 8 is a view illustrating configuration of an ECU and a display device in a fourth embodiment of the present disclosure;

FIG. 9 illustrates examples of a method of acquiring a sum of image information items in the fourth embodiment;

FIG. 10 is a view illustrating configuration of an ECU and a display device in a fifth embodiment of the present disclosure;

FIG. 11 is a view illustrating specific configuration of the display device illustrated in FIG. 10;

FIG. 12 illustrates contents of lower-order bits of a last row of an odd-numbered frame;

FIG. 13 is a view for describing operation of storing frame identification data set to the odd-numbered frame in a storage circuit unit;

FIG. 14 illustrates contents of lower-order bits of a last row of an even-numbered frame; and

FIG. 15 is a view for describing operation of storing frame identification data set to the even-numbered frame in a storage circuit unit.

### EMBODIMENTS FOR CARRYING OUT INVENTION

### First Embodiment

A first embodiment of the present disclosure will be described below with reference to the drawings. A display apparatus in accordance with the present embodiment is used in an electronic mirror system that displays a video image captured by a camera or the like on a display as it is. The electronic mirror system is mounted in a vehicle and so on. This enables a video image outside the vehicle to be displayed indoors as it is.

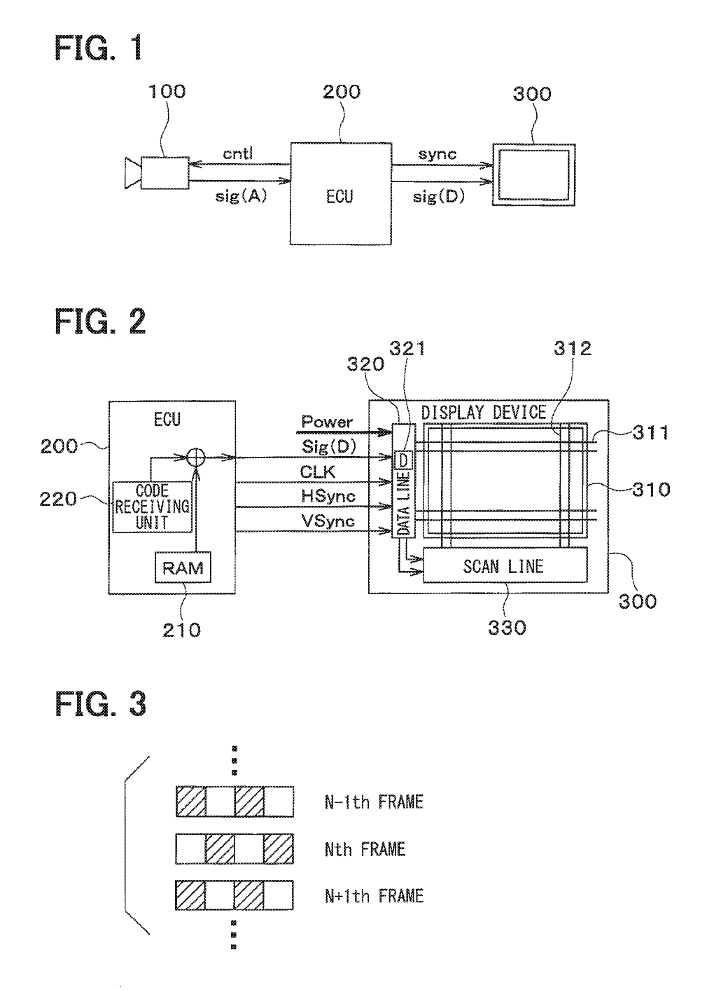

As illustrated in FIG. 1, such electronic mirror system is configured of a camera 100, an ECU 200 (Electronic Control Unit), and a display device 300.

The camera 100 is an image-capturing device that captures, for example, images of the outside of a vehicle. The camera 100 is installed within a vehicle, for example. The camera 100 inputs a control signal (cntl) from the ECU 200, and captures a plurality of images for, for example, one second according to the control signal. The camera 100 outputs image data of captured image, which is a video signal (sig (A)), to the ECU 200. For example, the video signal is an NTSC signal. That is, the video signal is outputted from the camera 100 to the ECU 200 as a signal for each frame.

The ECU 200 receives an input of the video signal from the camera 100, and processes each frame based on the video signal that can be displayed on the display device 300 to generate a display signal (sig (D)). The ECU 200 functions to control the camera 100 according to the control signal, to process brightness and the like of an image for each frame contained in the video signal, and output the display signal to the display device 300.

To perform each of the functions, the ECU 200 has a microcomputer not illustrated. The microcomputer includes a CPU that executes a command, a ROM that stores a program, an A/D converter, a D/A converter, and an I/O that inputs and outputs a signal.

As illustrated in FIG. 2, the microcomputer includes a RAM 210 and a code receiving unit 220. The RAM 210 is a memory that stores data of the frame of the image processed by the CPU.

The code receiving unit 220 is a setting device that sets identification information, which can identify successive frames among the plurality of frames contained in the display signals processed by the CPU, for each frame. In other words, the code receiving unit 220 sets, for each frame, identification information that identify one frame among continuous frames and the frame next to the one frame.

In the present embodiment, the code receiving unit 220 sets different codes, as the identification information, to successive frames among the plurality of frames contained in the display signals. As illustrated in FIG. 3, a code of the N^{th} frame is set to be different from a code of the N−1^{th} frame. A code of the N+1^{th} frame is set to be different from the code of the N^{th} frame.

Here, although the code of the N−1th frame is the same as the code of the N+1^{th} frame, these frames have different frame contents. Since the successive frames only needs to be different from each other as described above, at least two types of codes may be previously prepared. As a matter of course, three or more codes may be used.

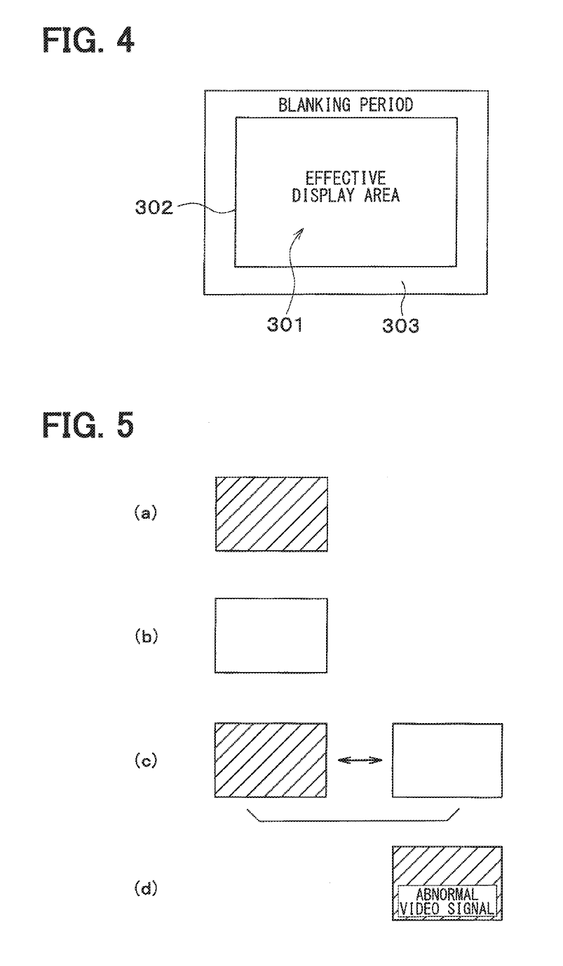

The code receiving unit 220 gives a code to data of the frame outputted from the RAM 210 to the display device 300. In the present embodiment, as illustrated in FIG. 4, the code receiving unit 220 sets a code at a position corresponding to a blanking period 303 on the periphery of an effective display area 302 that is viewable as a screen 301 of the display device 300.

Accordingly, the ECU 200 outputs the display signals containing a plurality of frames with given codes to the display device 300. To display a video image on the screen 301 of the display device 300, the ECU 200 outputs a clock signal (CLK), a horizontal synchronization signal (HSync), a vertical synchronization signal (VSync) to the display device 300, in addition to the display signal.

The display device 300 is a display device that displays a video image captured by the camera 100. That is, the display device 300 inputs the display signals from the ECU 200, and continuously displays the images of the plurality of frames contained in the display signals on the screen 301 to display the video image. The display device 300 includes a display unit 310, a data line driving circuit unit 320, and a scan line driving circuit unit 330.

The display unit 310 is a dot-matrix type in which a plurality of data lines 311 and a plurality of scan lines 312 cross each other. That is, intersection points of the data lines 311 and the scan lines 312 correspond to pixels, and an area surrounded with the intersection points is the effective display area 302 (screen 301). The display unit 310 is configured as a liquid crystal panel, an organic EL panel, or the like.

The data line driving circuit unit 320 applies a driving voltage to each of the data lines 311 according to the display signal and the horizontal synchronization signal. The data line driving circuit unit 320 is a so-called data driver IC. The data line driving circuit unit 320 is operated by externally receiving electric power (power).

The scan line driving circuit unit 330 is configured to receive the clock signal and the vertical synchronization signal from the data line driving circuit unit 320, and to apply a driving voltage to each of the scan lines 312 based on these signals. The scan line driving circuit unit 330 is a so-called scan driver.

In the display device 300, the data line driving circuit unit 320 includes a determination circuit unit 321. The determination circuit unit 321 is a detection device that compares identification information on a frame of the image displayed on the screen 301 of the display device 300 with identification information on a next frame of the image displayed on the screen 301 to detect whether the screen 301 freezes. That is, the determination circuit unit 321 detects that the screen 301 of the display device 300 freezes when there is a match in the items of the identification information on the both frames. The “next frame of the image displayed on the screen 301” described herein is not limited to the immediately following frame. For example, a frame of the image displayed on the screen 301 after 2 frames may be a frame to be compared. “There is a match in the items of the identification information” is not limited to that “the items of the identification information are completely identical to each other”, but includes that “the items are recognized to be identical to each other to some extent”.

In the present embodiment, the determination circuit unit 321 compares a code of the frame of the image displayed on the screen 301 with a code of the next frame of the image displayed on the screen 301, to detect whether the screen 301 freezes.

The data line driving circuit unit 320 has a correction function to correct the state where images of the same frames are displayed on the screen 301 when the determination circuit unit 321 detects that the screen 301 freezes.

Specifically, as illustrated in (a) of FIG. 5, the data line driving circuit unit 320 deletes the screen 301. That is, the data line driving circuit unit 320 displays black on the screen 301. As illustrated in (b) of FIG. 5, the data line driving circuit unit 320 fully lights the screen 301. That is, the data line driving circuit unit 320 displays a single color such as white on the screen 301.

As illustrated (c) of FIG. 5, the data line driving circuit unit 320 flashes the screen 301 in black and white. That is, the data line driving circuit unit 320 alternately displays two different colors. Alternately, as illustrated in (c) of FIG. 5, the data line driving circuit unit 320 displays abnormality on the screen 301. For example, displaying a term “video signal abnormal” explicitly indicates that the screen 301 freezes.

The data line driving circuit unit 320 can perform one of the correction methods illustrated in FIG. 5, correcting the state where the image of the same frame is continuously displayed on the screen 301. This can inform the user of the state where the screen 301 freezes. This is the entire configuration of the electronic mirror system according to the present embodiment.

Next, operations of detecting a freeze of the screen 301 and correcting the freeze in the electronic mirror system will be described. The ECU 200 outputs the control signal to the camera 100, causing the camera 100 to capture the image of surroundings of the camera, and inputting a video signal. The ECU 200 processes each frame contained in the video signal, and stores the processed frames in the RAM 210.

Then, the code receiving unit 220 gives a code to the position of the blanking period 303 of each frame outputted from the RAM 210 to the display device 300. At this time, the code receiving unit 220 gives different codes to successive frames. After that, the ECU 200 outputs each frame as a display signal to the display device 300 as appropriate. The ECU 200 outputs other signals such as the clock signal to the display device 300.

In the display device 300, the data line driving circuit unit 320 and the scan line driving circuit unit 330 continuously display images on the screen 301 of the display unit 310 based on a plurality of frames contained in the display signals. In this manner, the display device 300 displays the video image captured by the camera 100 on the display unit 310.

In the data line driving circuit unit 320, the determination circuit unit 321 compares the code given to the frame of the image displayed this time on the display unit 310 with the code given to the frame of the image displayed last time on the display unit 310. When the codes are different from each other, the determination circuit unit 321 determines that the screen 301 does not freeze.

On the contrary, when an abnormality occurs in any component of the electronic mirror system, such as the camera 100, the ECU 200, and the data line driving circuit unit 320, the image of the same frame is continuously displayed in the display unit 310. That is, the screen 301 freezes. In this case, since the code given to the frame of the image displayed last time on the display unit 310 matches the code given to the frame of the image displayed this time on the display unit 310, the determination circuit unit 321 detects that the screen 301 freezes. The determination circuit unit 321 outputs a detection result to a cancellation unit of the data line driving circuit unit 320.

After that, the data line driving circuit unit 320 displays any of types illustrated in FIG. 5 on the screen 301 so as not to continuously display the same image of the same frame. Then, when the determination circuit unit 321 determines that the codes are different from each other, the data line driving circuit unit 320 causes the video image to be displayed on the screen 301 according to the display signals. That is, when the electronic mirror system returns to the normal state, the data line driving circuit unit 320 causes the video image captured by the camera 100 on the screen 301 again.

As described above, in the present embodiment, the ECU 200 gives a code as identification information to each frame, and the determination circuit unit 321 compares codes of the successive frames with each other, thereby detecting whether the screen 301 freezes.

As described above, since the code receiving unit 220 gives, for each frame, different codes to the successive frames, the determination circuit: unit 321 can detect whether the image continuously displayed on the screen 301 of the display device 300 is the same image of the same frame. Accordingly, this can detect a freeze of the screen 301 of the display device 300.

When the freeze of the screen 301 is detected, the data line driving circuit unit 320 can correct the state where the screen 301 freezes. This can prevent the image displayed on the screen 301 from being wrongly recognized.

The camera 100 corresponds to an “image capturing device”, and the ECU 200 corresponds to a processing device. The display device 300 corresponds to a display device. The code receiving unit 220 corresponds to setting devices, and the determination circuit unit 321 corresponds to detection devices. Further, the data line driving circuit unit 320 corresponds to a cancellation unit, and the data line driving circuit unit 320 corresponds to a driving circuit unit.

### Second Embodiment

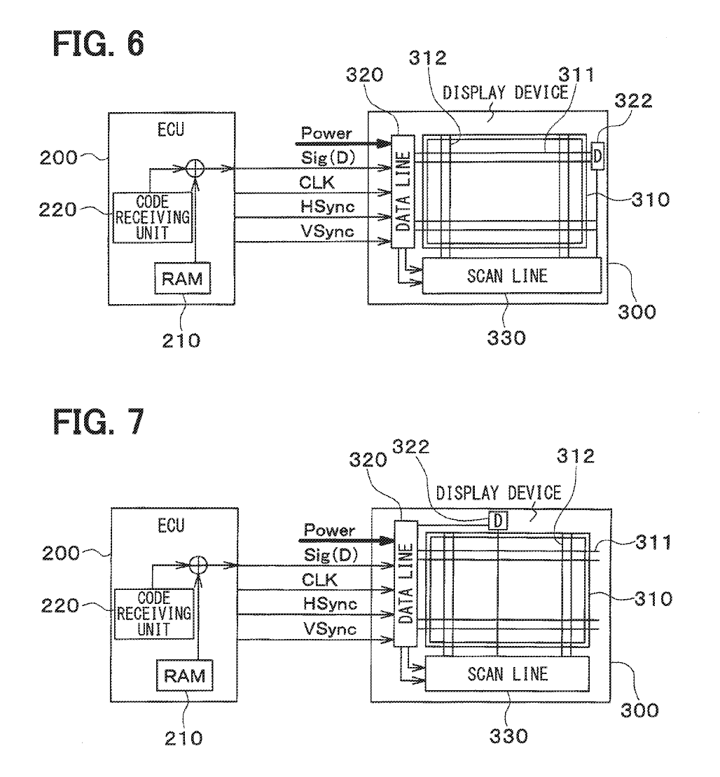

Differences between the present embodiment and the first embodiment will be described below. As illustrated in FIG. 6, a determination circuit unit 322 is provided around the effective display area 302 of the display unit 310. The determination circuit unit 322 is electrically connected to the data lines 311 on the opposite side to the data line driving circuit unit 320. The determination circuit unit 322 is provided around the effective display area 302, and compares the codes of successive frames as described above, monitoring a freeze of the screen 301.

The data line driving circuit unit 320 and the scan line driving circuit unit 330 correspond to the driving circuit unit.

### Third Embodiment

Differences between the present embodiment and the second embodiment will be described below. As illustrated in FIG. 7, the determination circuit unit 322 is disposed around the effective display area 302 of the display unit 310, and is electrically connected to the scan lines 312 on the opposite side to the scan line driving circuit unit 330. The determination circuit unit 322 can also monitor the codes via the scan lines 312.

### Fourth Embodiment

Differences between the present embodiment and the first to the third embodiments will be described below. In each of the above-mentioned embodiments, the ECU 200 gives identification information to each frame. In the present embodiment, however, identification information of each frame is set in the display device 300.

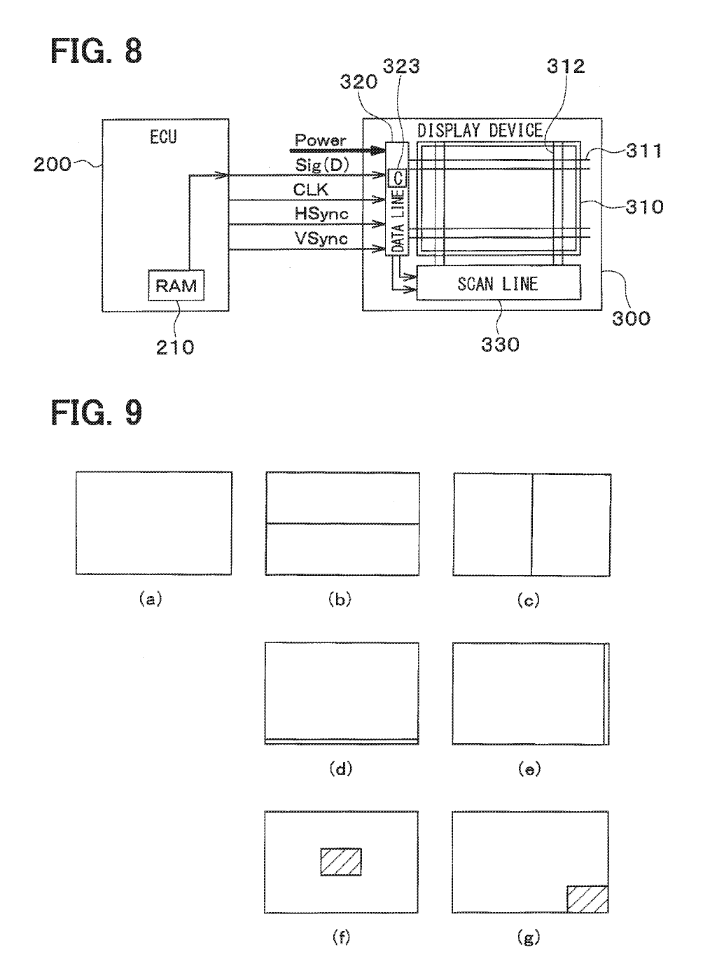

The ECU 200 has a function to control the camera 100, a function to apply image processing to each frame contained in video signals, and a function to output display signals to the display device 300. The frame of the processed image contains image information items such as brightness and chromaticity. As illustrated in FIG. 8, the ECU 200 stores the display signals after image processing in the RAM 210, and outputs the display signals to the display device 300 at any time.

As described above, the display device 300 includes a display unit 310, a data line driving circuit unit 320, and a scan line driving circuit unit 330. The data line driving circuit unit 320 has a function to acquire, for each frame, a sum of the image information items contained in the frame, as identification information.

The data line driving circuit unit 320 includes a checksum circuit unit 323. The checksum circuit unit 323 is a detection device that compares a sum of image information items of a frame of an image displayed on the screen 301 with a sum of image information items of a next frame of the image displayed on the screen 301, to detect whether the screen 301 freezes. The “next frame of the image displayed on the screen 301” described herein is not limited to a frame immediately after the concerned frame. For example, a frame of the image displayed after 2 frames on the screen 301 may be compared.

Specifically, as illustrated in (a) of FIG. 9, the checksum circuit unit 323 calculates a sum of brightness of the image displayed on the screen 301 as a sum of the image information items (identification information). As illustrated in (b) of FIG. 9, the checksum circuit unit 323 calculates a sum of brightness of one central row on the screen 301 as the sum of image information items. As illustrated in (c) of FIG. 9, the checksum circuit unit 323 calculates a sum of brightness of one central column on the screen 301 as the sum of image information items.

The checksum circuit unit 323 calculates a sum of brightness of a last row on the screen 301 as the sum of image information items as illustrated in (d) of FIG. 9, or calculates a sum of brightness of a last column on the screen 301 as the sum of image information items as illustrated in (e) of FIG. 9.

The checksum circuit unit 323 calculates a sum of brightness of a central area on the screen 301 as the sum of image information items as illustrated in (f) of FIG. 9, or calculates a sum of brightness of a most downstream area on the screen 301 as the sum of image information items as illustrated in (g) of FIG. 9. In calculating brightness of one row or one column, the sum of brightness of a previous frame may match the sum of brightness of a next frame. However, such accidental matching can be prevented by calculating the brightness of a certain area.

The checksum circuit unit 323 detects that the screen 301 of the display device 300 freezes when there is a match in the sums of image information. “There is a match in the sums of image information” described herein includes that the case where brightness or chromaticity completely matches, as well as the case where brightness or chromaticity matches in a certain range.

When the checksum circuit unit 323 detects that the screen 301 freezes, data line driving circuit unit 320 performs any of the cancellation methods illustrated in (a) to (d) of FIG. 5. As another method, the data line driving circuit unit 320 resets the CPU of the ECU 200. That is, the data line driving circuit unit 320 restarts a software of the ECU 200. When the screen 301 freezes for some reason related to the ECU 200, the resetting enables the screen 301 to return to the normal state. The freeze cancellation processing can inform the user that the screen 301 freezes.

The data line driving circuit unit 320 corresponds to the setting devices and the driving circuit unit, and the checksum circuit unit 323 corresponds to the detection device.

### Fifth Embodiment

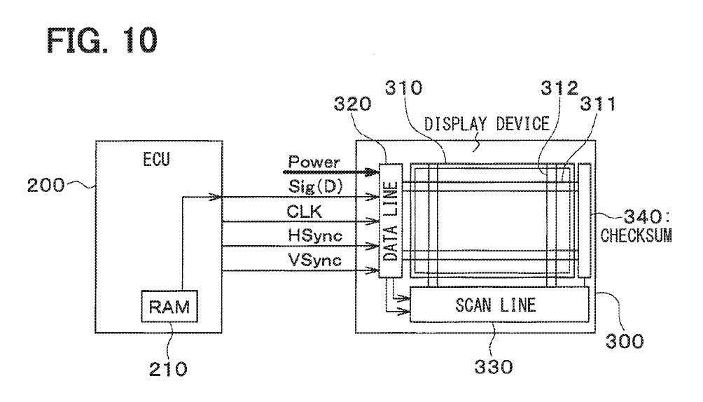

Differences between the present embodiment and the fourth embodiment will be described below. As illustrated in FIG. 10, the display device 300 includes a display unit 310, a data line driving circuit unit 320, a scan line driving circuit unit 330, and a checksum circuit unit 340.

The data line driving circuit unit 320 gives identification information to a lower-order 1 bit of each pixel in the last row of the frame. At this time, the data line driving circuit unit 320 gives different identification information to an odd-numbered frame and an even-numbered frame. Thus, since successive frames have different identification information, the successive frames can be identified.

The data line driving circuit unit 320 applies an analog voltage as a driving voltage to the data lines 311, and sets 0V corresponding to “0” of a digital signal or 5V corresponding to “1” of a digital signal, which is identification information, to a lower-order bit in the last row of the frame.

The checksum circuit unit 340 is a detection device that compares items of identification information of frames set by the data line driving circuit unit 320 to detect whether the screen 301 freezes. In the present embodiment, the checksum circuit unit 340 is provided around the effective display area 302, which is the screen 301, in the display unit 310, and is electrically connected to the data lines 311 on the opposite side to the data line driving circuit unit 320.

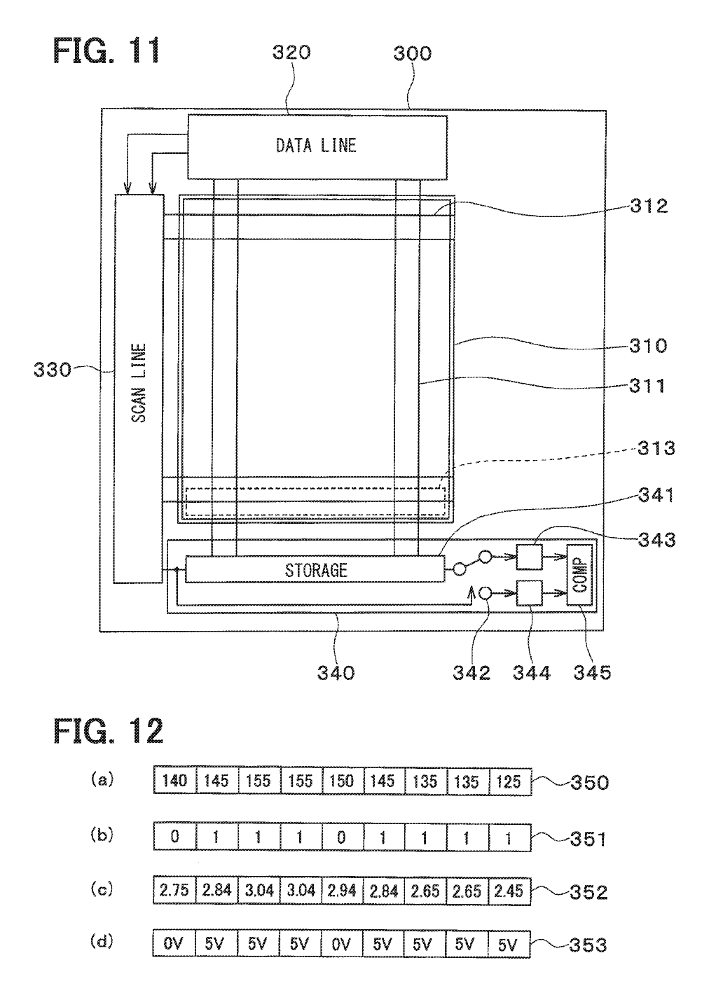

As illustrated in FIG. 11, the checksum circuit unit 340 includes a storage circuit unit 341, a switching unit 342, a first sum circuit unit 343, a second sum circuit unit 344, and a comparison circuit unit 345.

The storage circuit unit 341 is arranged in a later stage of the last row of the display unit 310. The storage circuit unit 341 stores, for each data line 311, the lower-order bit set to a pixel group 313 in the last row of the effective display area 302 of the frame. As discussed above, since the identification information is set as the analog voltage by the data line driving circuit unit 320, the storage circuit unit 341 stores a value of the analog voltage. The storage circuit unit 341 may store a plurality of lower-order bits of the frame.

The switching unit 342 switches connection between the storage circuit unit 341 and the first sum circuit unit 343 or between the storage circuit unit 341 and the second sum circuit unit 344 according to a command from the scan line driving circuit unit 330. For example, when an image of the even-numbered frame is displayed on the display unit 310, the switching unit 342 connects the storage circuit unit 341 to the first sum circuit unit 343. When an image of the odd-numbered frame is displayed in the display unit 310, the switching unit 312 connects the storage circuit unit 341 to the second sum circuit unit 344.

The first sum circuit unit 343 calculates a sum of lower-order bits corresponding to even-numbered frames stored in the storage circuit unit 341. The second sum circuit unit 344 calculates a sum of lower-order bits corresponding to odd-numbered frames stored in the storage circuit unit 311.

The comparison circuit unit 345 serves to compare the sum acquired by the first sum circuit unit 313 with the sum acquired by the second sum circuit unit 344. The comparison circuit unit 345 determines that the screen 301 does not freeze when the sums do not match each other, and determines that the screen 301 freezes when the sums match each other. This is the configuration of the display device 300 in the present embodiment.

Next, operation of the display device 300 will be described. First, the data line driving circuit unit 320 gives frame identification data 351 in FIG. 12B to a lower-order bit of pixel data 350 (8 bits) in the last row of the odd-numbered frame in (a) of FIG. 12, the frame identification data 351 being identification information (1 bit).

The data line driving circuit unit 320 performs D/A conversion of the data 350, 351, thereby generating an analog voltage 352 of the pixel data 350 in (c) of FIG. 12 as well as the analog voltage 353 of the frame identification data 351 in (d) of FIG. 12.

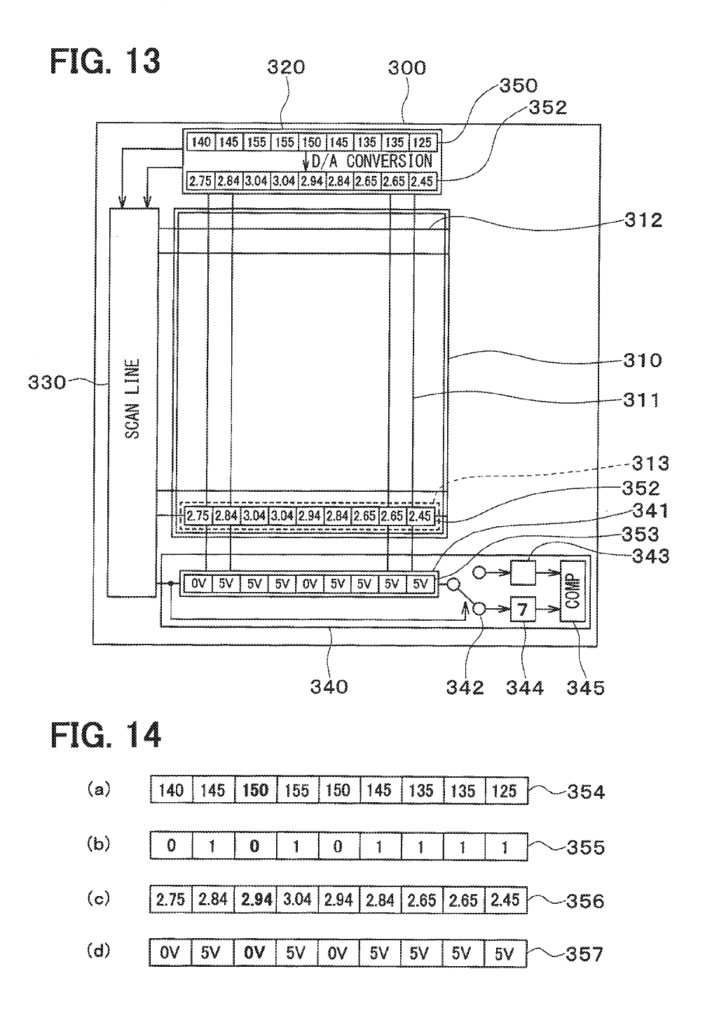

As illustrated in FIG. 13, the data line driving circuit unit 320 applies the analog voltage 352 of the pixel data 350 to each data line 311. The storage circuit unit 341 stores the analog voltage 353 corresponding to the frame identification data 351 for each data line 311. When the image of the odd-numbered frame is displayed on the screen 301 of the display unit 310, the switching unit 342 connects the storage circuit unit 341 to the second sum circuit unit 344. Accordingly, the second sum circuit unit 344 acquires a sum of the number of the analog voltages corresponding to a digital signal “1” stored in the storage circuit unit 341. The sum of the frame identification data 351 is “7”.

Subsequently, the data line driving circuit unit 320 gives frame identification data 355 illustrated in (b) of FIG. 14 to a lower-order bit of pixel data 354 (8 bits) in the last row of the even-numbered frame in (a) of FIG. 14, the frame identification data 355 being identification information (1 bit). The frame identification data 355 is partially different from the frame identification data 351 related to the odd-numbered frame.

The data line driving circuit unit 320 performs D/A conversion of data 354, 355, thereby generating an analog voltage 356 of the pixel data 354 in (c) of FIG. 14 as well as an analog voltage 357 of the frame identification data 355 in (d) of FIG. 14.

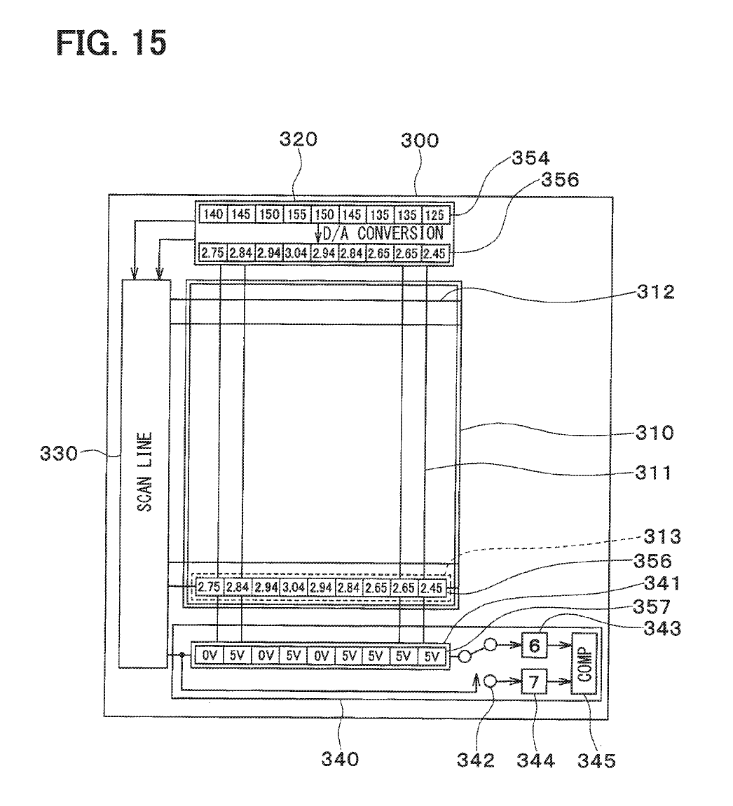

As illustrated in FIG. 15, the data line driving circuit unit 320 applies the analog voltage 356 of the pixel data 354 to each data line 311. The storage circuit unit 341 stores the analog voltage 357 corresponding to the frame identification data 355 for each data line 311. When the image of the even-numbered frame is displayed on the screen 301 of the display unit 310, the switching unit 342 connects the storage circuit unit 341 to the first sum circuit unit 343. Accordingly, the first sum circuit unit 343 acquires a sum of the number of the analog voltages corresponding to a digital signal “1” stored in the storage circuit unit 341. The sum of the frame identification data 355 is “6”.

After that, the comparison circuit unit 345 compares the sums of the sum circuit units 343, 344 with each other. Since the sum values are different from each other in the above example, the comparison circuit unit 345 determines that the screen 301 does not freeze. Then, in the state where the first sum circuit unit 343 has the identification information on the even-numbered frame, the second sum circuit unit 344 acquires identification information on the next odd-numbered frame, and the comparison circuit unit 345 compares sum values with each other. The sum circuit unit 343, 344 update the sum values as appropriate, and the comparison circuit unit 345 compares sum values at each updating. In this manner, the comparison circuit unit 345 determines whether successive frames are identical to each other.

When the sum values match each other, the comparison circuit unit 345 determines that the screen 301 freezes, and outputs a determination result to the data line driving circuit unit 320. The data line driving circuit unit 320 cancels the freeze of the screen 301 by the cancellation method in the fourth embodiment. As described above, the checksum circuit unit 340 can determine the video image.

The checksum circuit unit 340 corresponds to the detection device.

### Other Embodiments

The configuration of the electronic mirror system in the above-mentioned embodiments is an example. The present invention is not limited to the configuration, and may be modified so as to realize the system. For example, the camera 100 is not essential, and video signals of a video image captured by the camera 100 may be inputted to the ECU 200. In this case, the video signals are not necessarily inputted to the ECU 200 by wire, and the ECU 200 may wirelessly receive the video signals from the camera 100 in the state where the camera 100 is electrically separated from the ECU 200.

As long as electronic mirror system can be configured, the camera 100 and the ECU 200 may be integrated, or the ECU 200 and the display device 300 may be integrated.

Although the determination circuit unit 321 is arranged in the data line driving circuit unit 320 in the first embodiment, the determination circuit unit 321 may be arranged in the scan line driving circuit unit 330. Similarly, the checksum circuit unit 323 is arranged in the data line driving circuit unit 320 in the fourth embodiment, the checksum circuit unit 323 may be arranged in the scan line driving circuit unit 330.

The identification information of the frame is given to the blanking period 303 located on the periphery of the effective display area 302 in the first to the third embodiments. This is an example of the position where the identification information is given. Therefore, the identification information may be given to any position other than the blanking period 303.

In each of the above-mentioned embodiments, the electronic mirror system is mounted in a vehicle, which is an example of application of the electronic mirror system. Therefore, the electronic mirror system is not limited to be a vehicle-mounted system. While the present disclosure has been described with reference to embodiments thereof, it is to be understood that the disclosure is not limited to the embodiments and constructions. The present disclosure is intended to cover various modification and equivalent arrangements. In addition, the various combinations and configurations, other combinations and configurations, including more, less or only a single element, are also within the spirit and scope of the present disclosure.

1. A display apparatus comprising:
a processing device that receives video signals of a video image captured by an image capturing device and processes an image of a frame in a viewable state based on the video signals to generate display signals;
a display device that receives the display signals from the processing device and continuously displays, on a screen, images of a plurality of frames included in the display signals to display the video image;
a setting device that sets, for each one frame of the plurality of frames, identification information to identify successive frames among the plurality of frames included in the display signals; and
a detection device that compares the identification information of one frame of the image displayed on the display device with the identification information of a next one frame, which is next to the one frame, of the image displayed on the display device, and detects that the screen of the display device freezes when both of the identification information of the one frame and the identification information of the next one frame are identical.

2. The display apparatus according to claim 1, further comprising:
a cancellation unit that cancels a state where images of identical frames are displayed on the display device when the detection device detects that the screen freezes.

3. The display apparatus according to claim 1, wherein:
the setting device is arranged in the processing device, and includes a code receiving unit that sets a code different in the successive frames among the plurality of frames included in the display signals as the identification information; and
the detection device is arranged in the display device, and includes a determination circuit unit that compares the code of the one frame of the image displayed on the display device with the code of the next one frame of the image displayed on the display device, to detect a freeze of the screen.

4. The display apparatus according to claim 3,
wherein the code receiving unit sets the code at a position corresponding to a blanking period of the each one frame.

5. The display apparatus according to claim 3, wherein:
the display device includes a dot matrix-type display unit and a driving circuit unit applying a driving voltage to the display unit based on the display signals; and
the determination circuit unit is arranged in the driving circuit unit.

6. The display apparatus according to claim 3, wherein:
the display device includes a dot matrix-type display unit in which an effective display area is set as the screen, and a driving circuit unit applying a driving voltage to the display unit based on the display signals; and
the determination circuit unit is arranged around the effective display area of the display unit, and is electrically connected to the driving circuit unit.

7. The display apparatus according to claim 1, wherein:
the setting device is arranged in the display device, and acquires a sum of a plurality of image information items included in the each one frame as the identification information; and
the detection device is arranged in the display device, and includes a checksum circuit unit that compares the sum of the plurality of image information items of the one frame of the image displayed on the display device with the sum of the plurality of image information items of the next one frame of the image displayed on the display device, to detect whether the screen freezes.

8. The display apparatus according to claim 7, wherein:
the display device includes a dot matrix-type display unit and a driving circuit unit applying a driving voltage to the display unit based on the display signals; and
the checksum circuit unit is arranged in the driving circuit unit.

9. The display apparatus according to claim 7, wherein:
the display device includes a dot matrix-type display unit in which an effective display area is set as the screen, and a driving circuit unit applying a driving voltage to the display unit based on the display signals; and
the checksum circuit unit is arranged around the effective display area of the display unit, and is electrically connected to the driving circuit unit.

10. The display apparatus according to claim 1, further comprising the image capturing device.

11. The display apparatus according to claim 1, mounted at a vehicle.
